(19) United States
(12) Patent Application Publication
(10) Pub. No.: US 2026/0332894 A1
(43) Pub. Date: Oct. 22, 2026

(54) INFORMATION PROCESSING DEVICE, INFORMATION PROCESSING METHOD, AND PROGRAM

(71) Applicant: SONY GROUP CORPORATION, TOKYO (JP)

(72) Inventor: SOHHEI OKADA, TOKYO (JP)

(21) Appl. No.: 19/105,622

(22) PCT Filed: Jul. 5, 2023
(86) PCT No.: PCT/JP2023/024971

§ 371 Date: Feb. 21, 2025

(30) Foreign Application Priority Data
Aug. 30, 2022 (JP) 2022-136500

(51) Int. Cl. H04N 23/68; H04N 23/73

(52) U.S. Cl. CPC H04N 23/682; H04N 23/6811; H04N 23/6812; H04N 23/73

(57) ABSTRACT

An information processing device includes an adjustment unit that adjusts a value related to blur correction in an imaging device and a shutter speed, the imaging device including an electronic blur correction function that corrects a blur of image data and a control function for the shutter speed.

### TECHNICAL FIELD

The present technology relates to an information processing device, an information processing method, and a program.

### BACKGROUND ART

These days, cameras have a function of correcting a blur caused in a captured image due to movement of a hand of the user holding the camera, shaking of various devices on which the cameras are mounted, or the like. This blur correction function is useful, because an image with less blurring can be acquired even in a case where the imaging device moves. As for blur correction methods, there are a mechanical method, an optical method, an electronic method for performing correction by cutting out a portion corresponding to a blur amount from an output of an optical system and an image sensor capable of imaging a wider angle of view than an output, and the like. Recently, imaging devices having a horizontal maintaining function using information about a gyroscope sensor or an acceleration sensor have also been developed.

There are various methods for blur correction. For example, there is a proposed technique by which a first vibration isolator performs a vibration isolation process on image data, and a second vibration isolator performs a vibration isolation process again while performing a control process to eliminate the influence of the vibration isolation process performed by the first vibration isolator on the basis of auxiliary information regarding the vibration isolation process details output by the first vibration isolator, to realize highly accurate blur correction (Patent Document 1).

### CITATION LIST

### Patent Document

Patent Document 1: Japanese Patent Application Laid-Open No. 2015-216510.

### SUMMARY OF THE INVENTION

### Problems to be Solved by the Invention

As disclosed in Patent Document 1, various methods have been proposed to further increase the accuracy of the blur correction function. Further, an image corrected by an electronic blur correction function is an image including a motion blur when the imaging device is moving, and is an image not including any motion blur when the imaging device is not moving. Therefore, there also is a problem in that a difference appears between output results, and an image from which a greater feeling of strangeness is felt is obtained when the amount of movement of the imaging device is larger.

The present technology has been made in view of such points, and aims to provide an information processing device, an information processing method, and a program that can reduce a feeling of strangeness to be caused in a captured image in electronic blur correction.

### Solutions to Problems

To solve the above problems, a first technology relates to an information processing device including an adjustment unit that adjusts one of a value related to blur correction in an imaging device or a shutter speed, the imaging device including an electronic blur correction function that corrects a blur of image data and a control function for the shutter speed.

Further, a second technology relates to an information processing method including adjusting one of a value related to blur correction in an imaging device or a shutter speed, the imaging device including an electronic blur correction function that corrects a blur of image data and a control function for the shutter speed.

Furthermore, a third technology relates to a program for causing a computer to implement an information processing method including adjusting one of a value related to blur correction in an imaging device or a shutter speed, the imaging device including an electronic blur correction function that corrects a blur of image data and a control function for the shutter speed.

### BRIEF DESCRIPTION OF DRAWINGS

FIG. 1 is a diagram illustrating a first example for explaining a problem to be solved by the present technology.

FIG. 2 is a diagram illustrating a second example for explaining a problem to be solved by the present technology.

FIG. 3 is a diagram illustrating a third example for explaining a problem to be solved by the present technology.

FIG. 4 is a diagram illustrating a fourth example for explaining a problem to be solved by the present technology.

FIG. 5 is a block diagram illustrating the configurations of an imaging device 10 and an information processing device 300 according to a first embodiment.

FIG. 6 is an appearance diagram illustrating the configuration of a lens head 100.

FIG. 7 is a diagram for explaining a blur correction method.

FIG. 8 is a flowchart illustrating processing to be performed by the information processing device 300.

FIG. 9 is a graph illustrating adjustment data in the first embodiment.

FIG. 10 is an explanatory diagram in a case where imaging is performed by the imaging device 10 that performs the processing by the information processing device 300.

FIG. 11 is a block diagram illustrating the configurations of an imaging device 10 and an information processing device 300 according to a second embodiment.

FIG. 12 is a graph illustrating adjustment data in the second embodiment.

FIG. 13 is a block diagram illustrating the configurations of an imaging device 10 and an information processing device 300 according to a third embodiment.

FIG. 14 is a graph illustrating adjustment data in the third embodiment.

FIG. 15 is a block diagram illustrating the configurations of an imaging device 10 and an information processing device 300 according to a modification.

FIG. 16 is a graph illustrating a modification of correction data.

### MODE FOR CARRYING OUT THE INVENTION

In the description below, embodiments of the present technology will be explained with reference to the drawings.

Note that the description will be given in the following order.

<1. First Embodiment>

[1-1. Problems to Be Solved by the Present Technology]

[1-2. Configurations of an Imaging Device 10 and an Information Processing Device 300]

[1-3. Processing to Be Performed by the Information Processing Device 300]

<2. Second Embodiment>

[2-1. Configurations of an Imaging Device 10 and an Information Processing Device 300, and Processing to Be Performed by the Information Processing Device 300]

<3. Third Embodiment>

[3-1. Configurations of an Imaging Device 10 and an Information Processing Device 300, and Processing to Be Performed by the Information Processing Device 300]

<4. Modifications>

### 1. First Embodiment

### [1-1. Problems to Be Solved by the Present Technology]

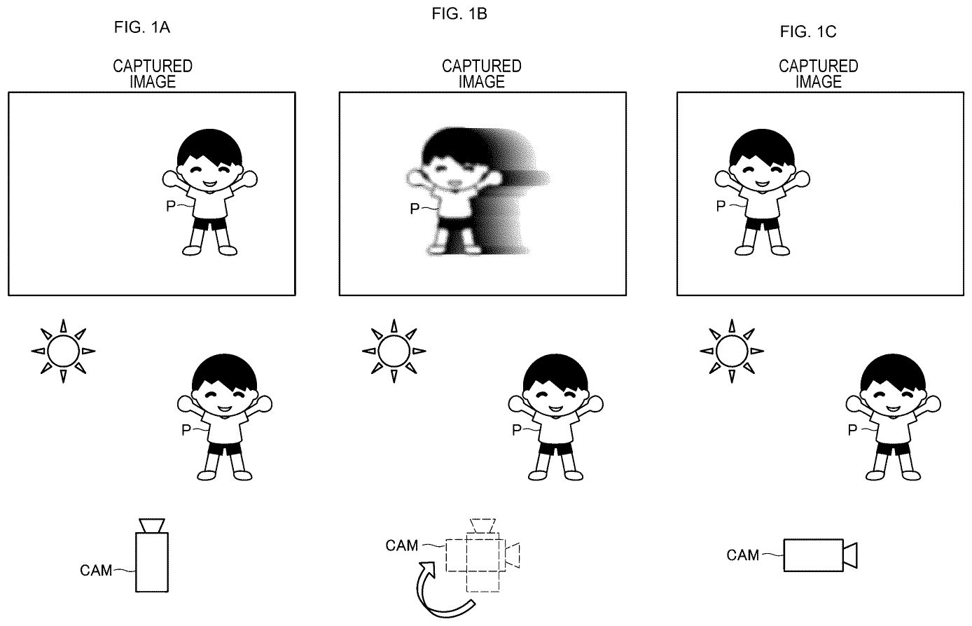

First, problems to be solved by the present technology are described. FIG. 1 is a first example for explaining a problem of capturing an image of a stationary subject P with an imaging device CAM not performing blur correction (or not having a blur correction function).

First, as illustrated in FIG. 1A, imaging is performed without moving the imaging device CAM, while the subject P is located on the right side of the imaging device CAM in the imaging direction of the imaging device CAM (the direction the lens faces). In this case, the subject P is located on the right side in the captured image, and no motion blur appears. A motion blur means that, due to movement of the subject P or the imaging device CAM, the subject P in the captured image is blurred as if it were flowing, or a residual image appears.

Further, as illustrated in FIG. 1B, when imaging is performed while the imaging device CAM is being panned clockwise in the state illustrated in FIG. 1A, blurring due to the movement of the imaging device CAM is not corrected, and the subject P is located on the left side in the captured image compared with the state illustrated FIG. 1A, which means that the composition has changed. Moreover, even when the subject P is not moving, a motion blur of the subject P occurs in the captured image due to the movement of the imaging device CAM.

Further, as illustrated in FIG. 1C, when the imaging device CAM is panned clockwise by 90 degrees, the subject P is located on the left side of the imaging device CAM in the imaging direction of the imaging device CAM (the direction the lens faces). When imaging is performed at the time when the imaging device CAM is panned clockwise by 90 degrees, no motion blur of the subject P appears in the captured image. However, since the blurring due to the movement of the imaging device CAM is not corrected, the subject P is located on the left side in the captured image, and the composition has changed from that of the captured image illustrated in FIG. 1A.

In a case where blur correction is not performed as described above (or where a blur correction function is not provided), when the imaging device CAM moves, the composition of the captured image changes, and further, a motion blur due to the movement of the imaging device CAM appears in the subject P. Thus, any strangeness does not appear in the captured image.

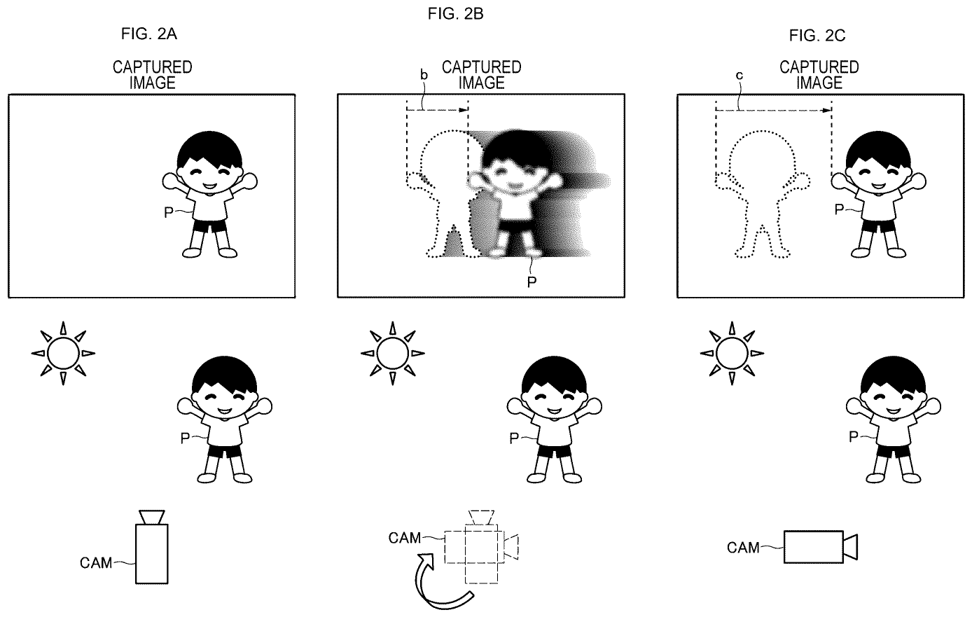

FIG. 2 is a second example for explaining a problem of capturing an image of a stationary subject P with an imaging device CAM performing blur correction. Note that the imaging conditions such as the positions of the imaging device CAM and the subject P are the same as those in the first example.

First, as illustrated in FIG. 2A, imaging is performed without moving the imaging device CAM, while the subject P is located on the right side of the imaging device CAM in the imaging direction of the imaging device CAM (the direction the lens faces). In this case, the subject P is located on the right side in the captured image.

Further, as illustrated in FIG. 2B, when imaging is performed while the imaging device CAM is being panned clockwise in the state illustrated in FIG. 2A, a motion blur of the subject P appears in the captured image due to the movement of the imaging device CAM. Furthermore, as blur correction is performed so as to cancel the movement of the imaging device CAM, a change in composition is suppressed, and the subject P is located on the right side in the captured image as in FIG. 2A. The length of an arrow b in FIG. 2B indicates the amount of movement of the position of the subject P due to the suppression of a change in the composition of the captured image by the blur correction.

Further, as illustrated in FIG. 2C, when the imaging device CAM is panned clockwise by 90 degrees, the subject P is located on the left side of the imaging device CAM in the imaging direction of the imaging device CAM (the direction the lens faces). As imaging is performed at the time when the imaging device CAM is panned clockwise by 90 degrees, blur correction is performed so as to cancel the movement of the imaging device CAM. Thus, a change in composition is suppressed, and the subject P is located on the right side in the captured image as in FIG. 2A. The length of an arrow c in FIG. 2C indicates the amount of movement of the position of the subject P due to the suppression of a change in the composition of the captured image by the blur correction.

In a case where blur correction is performed in such a manner, although a change in the composition of the captured image due to movement of the imaging device CAM is suppressed by the blur correction, the motion blur of the subject P due to the movement of the imaging device CAM remains, and therefore, a feeling of strangeness is caused in the captured image.

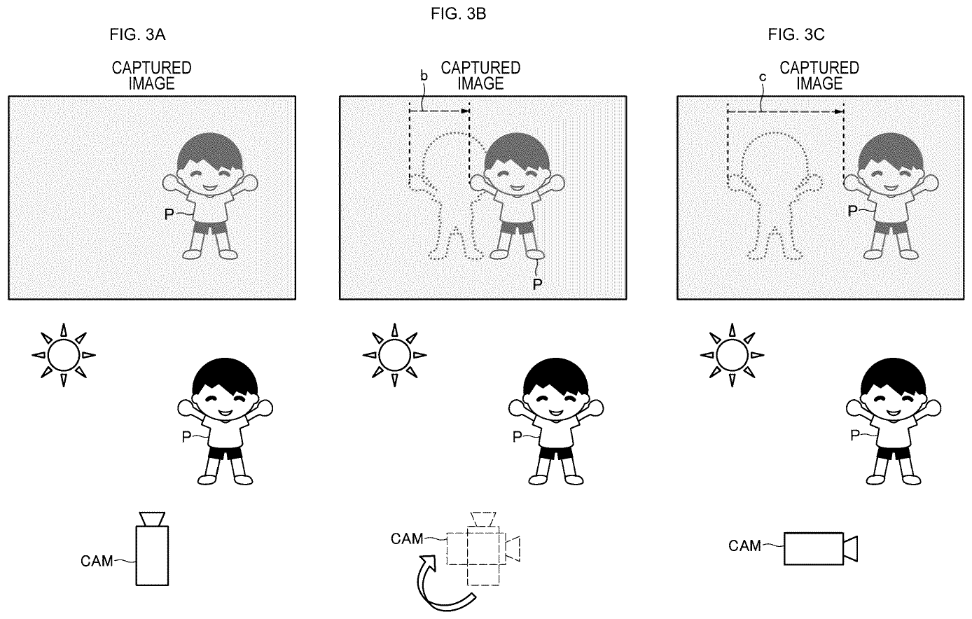

FIG. 3 is a third example for explaining a problem of performing blur correction to eliminate the feeling of strangeness caused by the blur correction illustrated in FIG. 2, and performing imaging by releasing the shutter at a higher shutter speed. Note that the imaging conditions such as the positions of the imaging device 10 and the subject P are the same as those in the first and second examples.

First, as illustrated in FIG. 3A, imaging is performed without moving the imaging device CAM, while the subject P is located on the right side of the imaging device CAM in the imaging direction of the imaging device CAM (the direction the lens faces). In this case, the subject P is located on the right side in the captured image, and no motion blur appears.

Further, as illustrated in FIG. 3B, when imaging is performed while the imaging device CAM is being panned clockwise in the state illustrated in FIG. 3A, the exposure time is shortened due to the releasing of the shutter, and the motion blur of the subject P to be caused by the movement of the imaging device CAM is suppressed. Furthermore, as blur correction is performed so as to cancel the movement of the imaging device CAM, a change in composition is suppressed, and the subject P is located on the right side in the captured image as in FIG. 3A. The length of an arrow b in FIG. 3B indicates the amount of movement of the position of the subject P due to the suppression of a change in the composition of the captured image by the blur correction.

Further, as illustrated in FIG. 3C, when the imaging device CAM is panned clockwise by 90 degrees, the subject P is located on the left side of the imaging device CAM in the imaging direction of the imaging device CAM (the direction the lens faces). As imaging is performed at the time when the imaging device CAM is panned clockwise by 90 degrees, blur correction is performed so as to cancel the movement of the imaging device CAM. Thus, a change in composition is suppressed, and the subject P is located on the right side in the captured image as in FIG. 3A. The length of an arrow c in FIG. 3C indicates the amount of movement of the position of the subject P due to the suppression of a change in the composition of the captured image by the blur correction.

As the shutter is released at such a high shutter speed, a motion blur can be suppressed. Further, a change in composition can be suppressed by the blur correction, and strangeness in the captured image can be eliminated. However, because the exposure time is shortened by the releasing of the shutter, there is a problem in that the captured image is darker than that in a case where the shutter is not released.

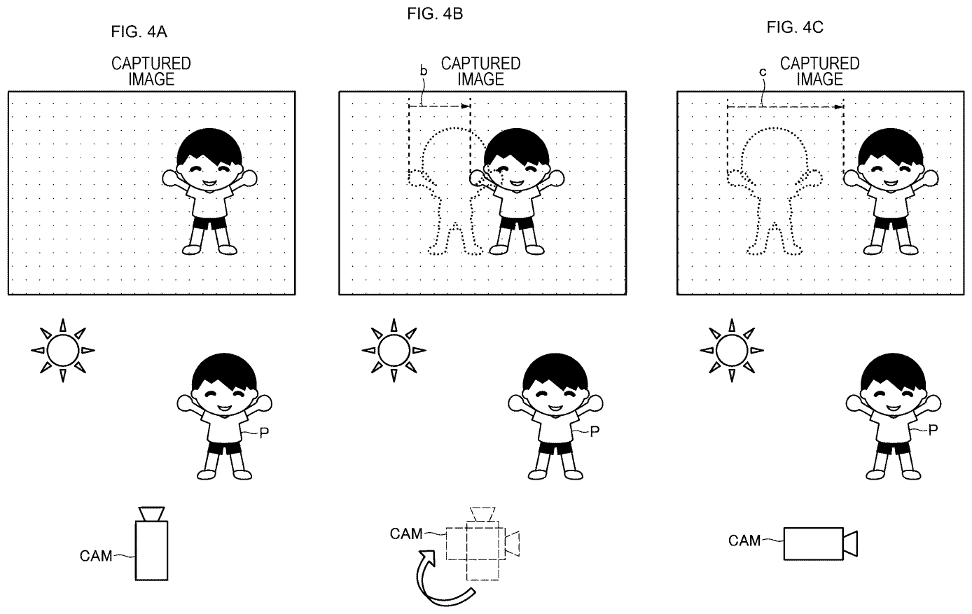

Further, to solve the problem in that the captured image becomes darker due to the releasing of the shutter, it is possible to correct the brightness of the captured image by adjusting the neutral density (ND), the iris, the gain, or the like. However, these kinds of image processing affect not only brightness but also image quality. Therefore, there is a problem in that noise increases due to an increase in gain, and image quality deteriorates, as illustrated in FIG. 4. Also, there are cases where the image quality desired by the user is not obtained. Further, in a case where the imaging environment is dark like nighttime, adjustment of the ND or the iris is not effective for image quality adjustment, and therefore, it is necessary to increase the gain. However, there also is a problem in that noise in the captured image increases with the increase in gain.

### [1-2. Configurations of an Imaging Device 10 and an Information Processing Device 300]

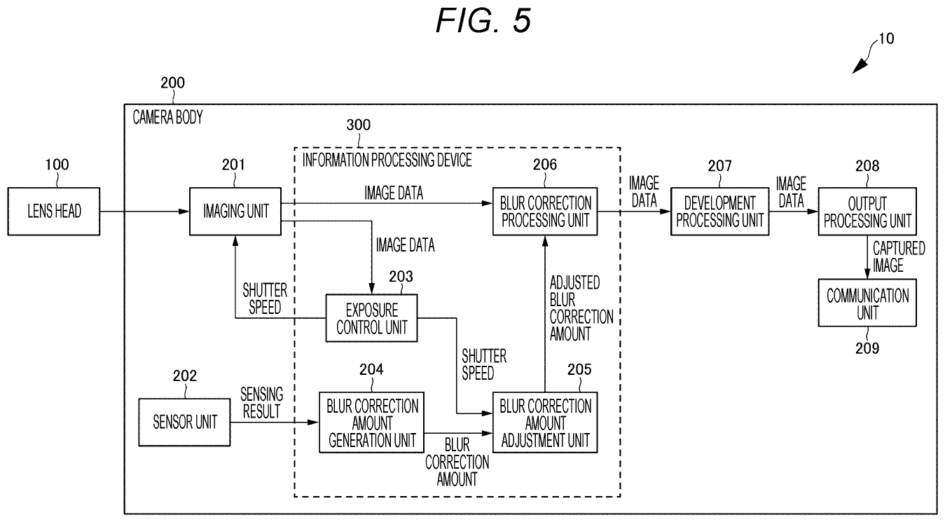

Next, the configurations of an imaging device 10 and an information processing device 300 of the present technology are described with reference to FIG. 5. The imaging device 10 includes a lens head 100, a camera body 200, and the information processing device 300.

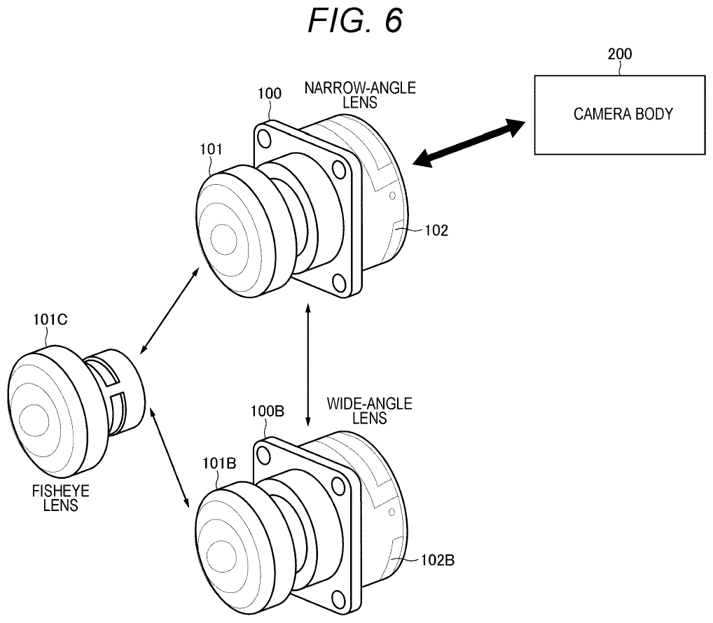

As illustrated in FIG. 6, the lens head 100 includes: a lens 101 including an optical lens for condensing light from a subject onto an imaging element and a focus lens for focusing; a lens information storage unit 102 that holds information regarding the lens 101; a lens driver (not shown) for moving the lens 101; and the like. An optical image of the subject obtained through the lens 101 is formed on an imaging element in an imaging unit 201.

The lens head 100 is formed as a separate member from the camera body 200, and is attached to the camera body 200. Accordingly, as illustrated in FIG. 6, the lens head 100 attached to the camera body 200 can be replaced with another lens head 100B. The lens head 100 is secured to the camera body 200 by screwing, for example. Being replaceable, the lens head 100 can be a target to be traded as a product. In a case where the lens head 100 is a target to be traded, the trading may be conducted, with a coaxial cable and a substrate being a set with the lens head 100.

The lens information storage unit 102 is formed with an erasable programmable read only memory (EPROM), for example.

Various pieces of information regarding the lens 101, such as a lens center deviation value that is an eigenvalue of the individual lens, lens shading correction data that is the fixed value of the lens type, distortion correction data, and lens type information, are stored beforehand into the lens information storage unit 102.

Since the information regarding the lens is stored in the lens information storage unit 102, the camera body 200 reads the information regarding the lens from the lens information storage unit 102 after replacement of the lens head 100 or at a time of activation of the imaging device 10. The camera body 200 then recognizes the lens 101 on the basis of the information regarding the lens 101 attached thereto, and automatically switches to an operation mode suitable for the lens 101, to perform imaging.

Further, as illustrated in FIG. 6, the lens 101 attached to the lens head 100 can be replaced with another lens. FIG. 6 illustrates an example in which the lens 101 attached to the lens head 100 can be replaced with a lens 101C, and further, a lens 101B attached to the lens head 100B can be replaced with the lens 101C. Various lenses such as a wide-angle lens, a narrow-angle lens, and a fisheye lens can be attached to the lens head 100.

The user can rewrite the information stored in the lens information storage unit 102 by connecting the lens head 100 to a device such as a personal computer. Accordingly, in a case where the lens 101 has been replaced, the user connects the lens head 100 to a personal computer or the like, and rewrites the information in the lens information storage unit 102 with the information about the newly attached lens. Thus, the camera body 200 can recognize a newly attached lens, and automatically switch to an operation mode suitable for the lens, to perform imaging.

The camera body 200 includes the imaging unit 201, a sensor unit 202, an exposure control unit 203, a blur correction amount generation unit 204, a blur correction amount adjustment unit 205, a blur correction processing unit 206, a development processing unit 207, an output processing unit 208, and a communication unit 209. The exposure control unit 203, the blur correction amount generation unit 204, the blur correction amount adjustment unit 205, and the blur correction processing unit 206 constitute the information processing device 300.

The imaging unit 201 includes an imaging element that photoelectrically converts incident light from the subject obtained through the lens 101 into a charge amount and generates image data, and a shutter mechanism. The imaging unit 201 outputs the generated image data to the exposure control unit 203 and the blur correction processing unit 206. As the imaging element, a charge coupled device (CCD), a complementary metal oxide semiconductor (CMOS), or the like is used. The shutter mechanism drives the shutter on the basis of a shutter speed acquired from the exposure control unit 203, to adjust the exposure time. The shutter mechanism may be of any type, such as a mechanical shutter type or an electronic shutter type.

The sensor unit 202 is various sensors that detect angular velocity and acceleration of movement of the imaging device 10.

Examples of the sensors include an inertial measurement unit (IMU), an inertial sensor (an acceleration sensor, an angular velocity sensor, a gyroscope sensor for two or three axis directions), and the like. A plurality of sensors may be used in combination as the sensor unit 202. The sensor unit 202 outputs a sensing result to the blur correction amount generation unit 204. Note that the sensor unit 202 may be formed as an external device, instead of being included in the camera body 200, and may transmit a sensing result to the camera body 200 by wired or wireless communication.

The exposure control unit 203 sets the shutter speed for adjusting the exposure time, on the basis of the user's input, the functions provided beforehand in the imaging device 10, or the like. In this manner, the camera body 200 has a shutter speed control function. The exposure control unit 203 outputs the set shutter speed to the imaging unit 201 and the blur correction amount adjustment unit 205.

The blur correction amount generation unit 204 generates a blur correction amount, on the basis of a general blur correction algorithm or the like using the sensing result acquired from the sensor unit 202. The blur correction amount generation unit 204 outputs the blur correction amount to the blur correction amount adjustment unit 205. The blur correction amount is the amount of movement of the cut-out position of image data in electronic blur correction for correcting blur by cutting out image data of a predetermined size from the image data output from the imaging unit 201, in accordance with the degree of the blur. The blur correction amount corresponds to the value related to blur correction in the claims.

The blur correction amount adjustment unit 205 holds adjustment data prepared in advance, and adjusts the blur correction amount on the basis of the adjustment data and the shutter speed acquired from the exposure control unit 203. The blur correction amount adjustment unit 205 outputs the blur correction amount subjected to the adjustment (referred to as the adjusted blur correction amount) to the blur correction processing unit 206.

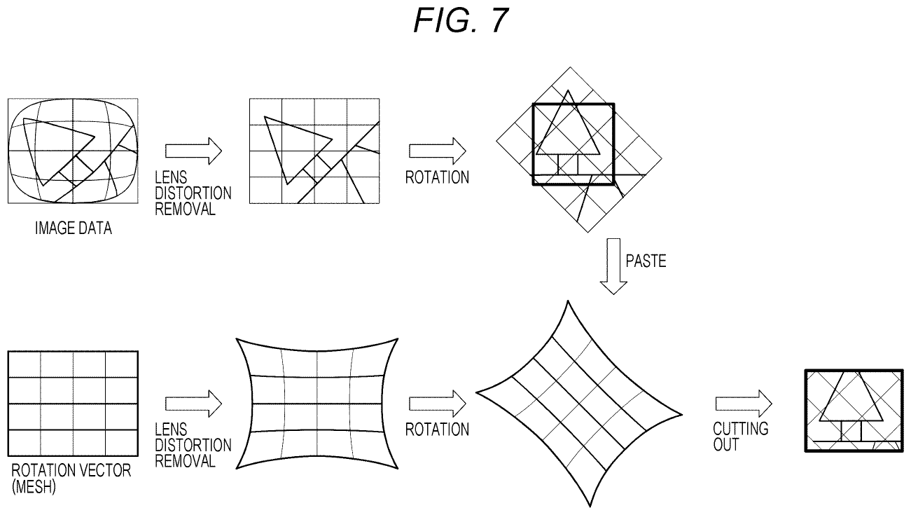

The blur correction processing unit 206 performs a blur correction process by an electronic blur correction method for cutting out an image of a predetermined size from the image data on the basis of the adjusted blur correction amount. As illustrated in FIG. 7, the blur correction processing unit 206 performs lens distortion removal and rotation processing on the input image data and the mesh of the rotation vector, pastes the image data to the mesh of the rotation vector, and cuts out image data of full HD (3840 in horizontal direction×2160 in vertical direction) from image data of 4K (1920 in horizontal direction×1080 in vertical direction), for example, to correct the blur. Note that the blur correction process may be a general method, and may be a method using a sensing result from a gyroscope sensor, an IMU, or the like serving as the sensor unit 202, a method for performing alignment with the past frames by image processing, or the like.

The development processing unit 207 performs predetermined image processing, such as a gain correction process, a white balance process, a color adjustment process, a Debayer process, and an aspect conversion process, for example, on the image data subjected to the blur correction process by the blur correction processing unit 206.

The output processing unit 208 performs an output process such as compression coding and output format conversion on the image data output from the development processing unit 207. As the coding method, Moving Picture Experts Group (MPEG), Joint Photographic Experts Group (JPEG), or the like is adopted, for example. In a case where the uncompressed RAW is stored as it is, compression coding is not necessarily performed. Examples of output formats include High-Definition Multimedia Interface (MDMI), Serial Digital Interface (SDI), and the like, for example.

The communication unit 209 is a communication module that communicates with another external device, the Internet, or the like. The communication method may be either a wired method or a wireless method, and specific examples thereof include cellular communication, the fourth-generation mobile communication system (4G), the fifth-generation mobile communication system (5G), Wi-Fi, Bluetooth (registered trademark), Near Field Communication (NFC), Ethernet (registered trademark), high-definition multimedia interface (HDMI (registered trademark)), and universal serial bus (USB). The image data output from the output processing unit 208 is transmitted as a captured image to an external device such as a personal computer via the communication unit 209 and a network. The imaging device 10 can also transmit a captured image to an external device in real time. Note that the imaging device 10 may not include the communication unit 209.

Although not shown in the drawings, the imaging device 10 may also include a storage medium, a display unit, a control unit, an input unit, and the like.

The storage medium is to store captured images, and is formed with a drive device for a portable recording medium such as magnetic tape or an optical disk, a hard disk drive (HDD), a solid state drive (SSD), or the like. The storage medium may be an external device connected to the imaging device 10 by wired or wireless connection. The image data output from the output processing unit 208 may be stored as a captured image in a storage medium.

The display unit is to display a captured image, a through-lens image, a graphical user interface (GUI), or the like. The display unit is embodied by a monitor display formed with a liquid crystal display (LCD), a plasma display panel (PDP), an organic electro luminescence (EL) panel, or the like, or an electronic view finder (EVF), for example. Note that the display unit may be an external device connected to the imaging device 10 by wired or wireless connection.

The control unit includes a central processing unit (CPU), a random access memory (RAM), a read only memory (ROM), and the like. The CPU performs various processes according to programs stored in the ROM, and issues commands, to control the entire imaging device 10 and the respective units.

The input unit is for the user to give inputs such as various instructions to the imaging device 10. When the user provides an input to the input unit, a control signal corresponding to the input is generated, and the imaging device 10 performs various processes in accordance with the control signal. The input unit may be a release button for release instructions, physical buttons for various operations, a touch panel, a touch screen integrally formed with the display unit, or the like.

The imaging device 10 and the information processing device 300 are formed as described above. The information processing device 300 may be formed as a dedicated device with hardware having the functions, or the imaging device 10 may have the functions as the information processing device 300 by execution of a program, and an information processing method may be implemented. The program may be installed into the imaging device 10 in advance, or may be downloaded or distributed via a storage medium or the like, and be installed into the imaging device 10 by the user. Also, the information processing device 300 may include the imaging unit 201.

### [1-3. Processing to Be Performed by the Information Processing Device 300]

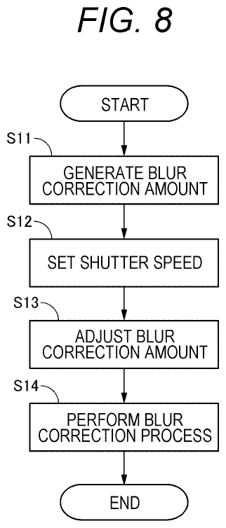

Next, processing to be performed by the information processing device 300 according to the first embodiment is described with reference to FIG. 8. To solve the above-described problem, in the imaging device 10 having an electronic blur correction function in the first embodiment, the blur correction amount adjustment unit 205 adjusts the blur correction amount on the basis of the shutter speed.

First, in step S11, the blur correction amount generation unit 204 generates a target amount of blur correction on the basis of a sensing result received from the sensor unit 202. The blur correction amount generation unit 204 outputs the target amount of blur correction to the blur correction amount adjustment unit 205. The target amount of blur correction is the value of 100% (maximum amount) of the blur correction amount calculated on the basis of the sensing result.

Next, in step S12, the exposure control unit 203 sets a shutter speed. The exposure control unit 203 outputs the shutter speed to the blur correction amount adjustment unit 205.

Note that step S11 and step S12 may be performed in reverse order, or may be performed at the same time or almost at the same time.

Next, in step S13, the blur correction amount adjustment unit 205 calculates the minimum amount of the blur correction amount by multiplying the target amount of blur correction by a predetermined magnification (0 to 1). The predetermined magnification may be set in advance at the time of designing or manufacturing the imaging device 10 or the information processing device 300, for example, or may be set by the user.

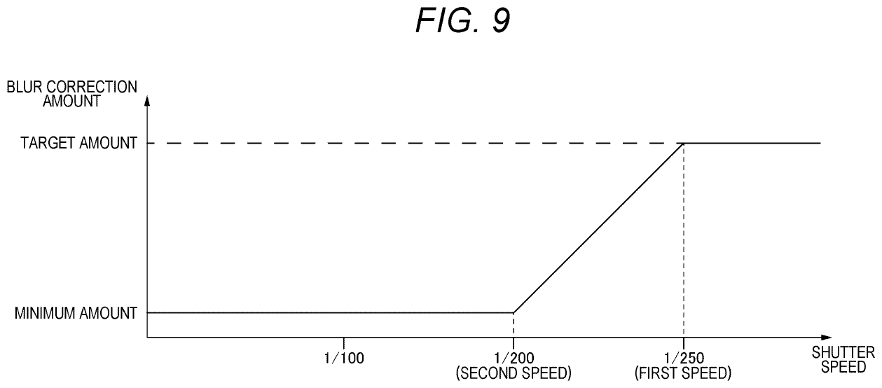

Further, the blur correction amount adjustment unit 205 adjusts the blur correction amount in accordance with the shutter speed, on the basis of blur correction amounts (the target amount and the minimum amount), the shutter speed, and the adjustment data prepared beforehand as illustrated in FIG. 9. The blur correction amount adjustment unit 205 outputs the adjusted blur correction amount to the blur correction processing unit 206.

Specifically, as illustrated in FIG. 9, in a case where the shutter speed is equal to or higher than a first speed, the blur correction amount is made larger than that in a case where the shutter speed is lower than the first speed, and is adjusted to the target amount. Also, in a case where the shutter speed is equal to or lower than a second speed lower than the first speed, the blur correction amount is made smaller than that in a case where the shutter speed is higher than the second speed, and is adjusted to the minimum amount. Further, in a case where the shutter speed is equal to or higher than the second speed, and is equal to or lower than the first speed, the blur correction amount is adjusted so as to approach the target amount as the shutter speed increases. Note that the characteristics of the adjustment data illustrated in FIG. 9 may change exponentially instead of linearly, or may change quadratically, and may be adjusted depending on the use case.

The shutter speed is increased to strongly suppress a motion blur of the subject in the captured image, and the shutter speed is lowered to weakly suppress a motion blur of the subject. Further, the adjusted blur correction amount is increased to strongly suppress a change in composition, and the adjusted blur correction amount is decreased to weakly suppress a change in composition.

Note that, in FIG. 9, the first speed of the shutter speed is “ 1/250”, and the second speed is “ 1/200”. However, this is merely an example, and the present technology is not limited to these values.

In this manner, the blur correction amount adjustment unit 205 determines the adjusted blur correction amount by adjusting the blur correction amount in accordance with the shutter speed set by the exposure control unit 203.

In step S14, the blur correction processing unit 206 then performs a blur correction process on the image data, on the basis of the adjusted blur correction amount. The image data subjected to the blur correction process is output as a captured image after subjected to processing by the development processing unit 207 and the output processing unit 208.

In the above manner, the processing by the information processing device 300 according to the first embodiment is performed. As described above, if there is no change in composition due to blur correction even though there is a motion blur of the subject in the captured image, a feeling of strangeness is caused in the captured image. According to the first embodiment, however, when the shutter speed is lowered to weakly suppress a motion blur, the adjusted blur correction amount approaches the minimum amount and decreases, and a change in composition is also weakly suppressed. Thus, a feeling of strangeness in the captured image can be reduced.

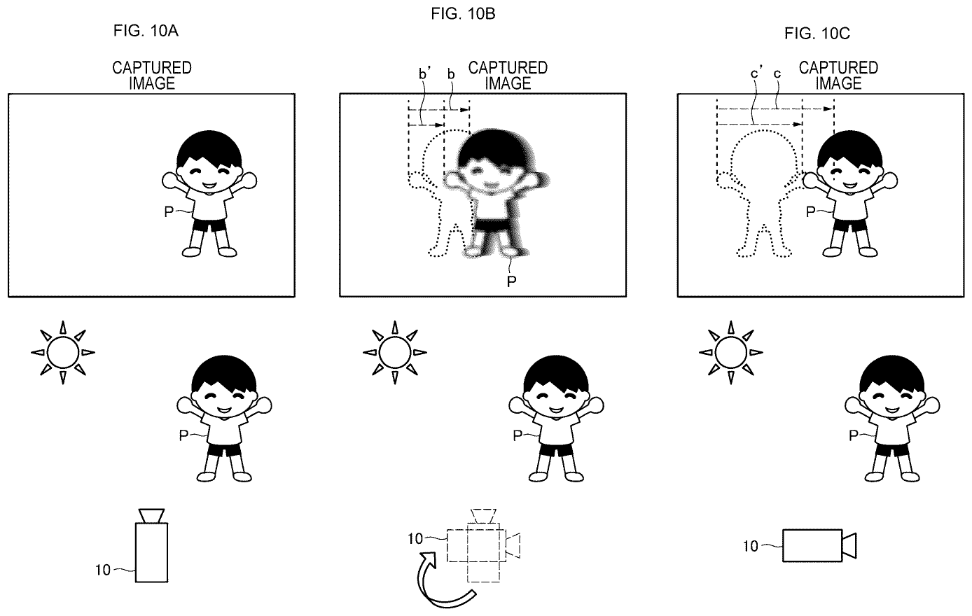

This aspect is now described with reference to FIG. 10. Note that the imaging conditions such as the positions of the imaging device 10 and the subject P are the same as those in the examples illustrated in FIGS. 1 to 4.

First, as illustrated in FIG. 10A, imaging is performed without moving the imaging device 10, while the subject P is located on the right side of the imaging device 10 in the imaging direction of the imaging device 10 (the direction the lens faces). In this case, the subject P is located on the right side in the captured image. This is similar to FIG. 2A.

Further, as illustrated in FIG. 10B, when imaging is performed while the imaging device 10 is being panned clockwise in the state illustrated in FIG. 10A, the exposure time is shortened due to releasing of the shutter, and the motion blur of the subject P to be caused by the movement of the imaging device 10 is suppressed. However, the shutter speed is set to be slow, and the motion blur is kept to a small amount. Therefore, the motion blur is smaller than that in FIG. 2B, but still remains.

Furthermore, blur correction is performed so as to cancel the movement of the imaging device 10, the composition is changed by the movement of the imaging device 10, and the blur correction is performed so that the subject P moved to the left side moves to the right side, and a change in composition is suppressed. However, when the shutter speed is lowered, the adjusted blur correction amount approaches the minimum amount and becomes smaller. Therefore, a change in composition is suppressed weakly, and the position of the subject P after the blur correction in FIG. 10B is located on the left side compared with that in FIG. 2B.

The length of an arrow b′ in FIG. 10B indicates the amount of movement of the position of the subject P due to the suppression of a change in the composition of the captured image by the blur correction. The amount of movement of the subject P indicated by the length of the arrow b′ is smaller than the amount of movement of the subject P due to the suppression of a change in composition in FIG. 2B as indicated by an arrow b.

That is, in FIG. 10B, the change in composition is suppressed more weakly than that in FIG. 2B.

Further, as illustrated in FIG. 10C, when the imaging device 10 is panned clockwise by 90 degrees, the subject P is located on the left side of the imaging device 10 in the imaging direction of the imaging device 10 (the direction the lens faces). When imaging is performed at a time when the imaging device 10 is panned clockwise by 90 degrees, blur correction is performed so as to cancel the movement of the imaging device 10. However, when the shutter speed is lowered, the adjusted blur correction amount approaches the minimum amount and becomes smaller. Therefore, a change in composition is suppressed weakly, and the position of the subject P after the blur correction in FIG. 10C is located on the left side compared with that in FIG. 2C.

The length of an arrow c′ in FIG. 10C indicates the amount of movement of the position of the subject P due to the suppression of a change in the composition of the captured image by the blur correction. The amount of movement of the subject P indicated by the length of the arrow c′ is smaller than the amount of movement of the subject P due to the suppression of a change in composition in FIG. 2C as indicated by an arrow c. That is, in FIG. 10C, the change in composition is suppressed more weakly than that in FIG. 2C.

As described above, when the shutter speed is lowered to weakly suppress a motion blur, the adjusted blur correction amount approaches the minimum amount and decreases, and a change in composition is also weakly suppressed. Thus, a feeling of strangeness in the captured image can be reduced.

On the other hand, when the shutter speed is increased to strongly suppress a motion blur, the adjusted blur correction amount approaches the target amount and increases, and a change in composition is also strongly suppressed. Thus, a feeling of strangeness in the captured image can also be reduced in this case.

Further, according to the first embodiment, in a case where the user does not want to shorten the exposure time (wants to lengthen the exposure time) to prevent the captured image from becoming darker, for example, when the shutter speed is made closer to the second speed, the adjusted blur correction amount approaches the minimum amount. Furthermore, when the shutter speed is set to the second speed or lower, the adjusted blur correction amount drops to the minimum value. As a result, the operation approaches an operation by a normal imaging device 10 not having an electronic camera-shake correction function, and thus, an image with less strangeness can be captured.

In this manner, an image in which both a “motion blur” and a “change in composition” due to movement of the imaging device 10 appear during imaging using the imaging device 10 having a blur correction function can be acquired with appropriate brightness and image quality.

The present technology can correct blurring due to movement of the imaging device 10 and suppress a change in composition while reducing strangeness in a captured image, and, because of this, is useful in a case where movement or vibration of the imaging device 10 is large. For example, the present technology is useful in a case where the present technology is applied to a motorcycle as a mobile body, and the front or rear of the motorcycle, the face of the rider, or the like is imaged during running. Note that the mobile body may not be a motorcycle, but may be a bicycle, an automobile, a drone, a ship, a person, or the like, for example. Furthermore, the imaging device 10 is not limited to one mounted on a mobile body, but may be a digital camera, a single-lens reflex camera, a camcorder, a camera for professional use, an imaging device with a professional specification, or the like that is used by a person holding it in the hand.

### 2. Second Embodiment

### [2-1. Configurations of an Imaging Device 10 and an Information Processing Device 300, and Processing to Be Performed by the Information Processing Device 300]

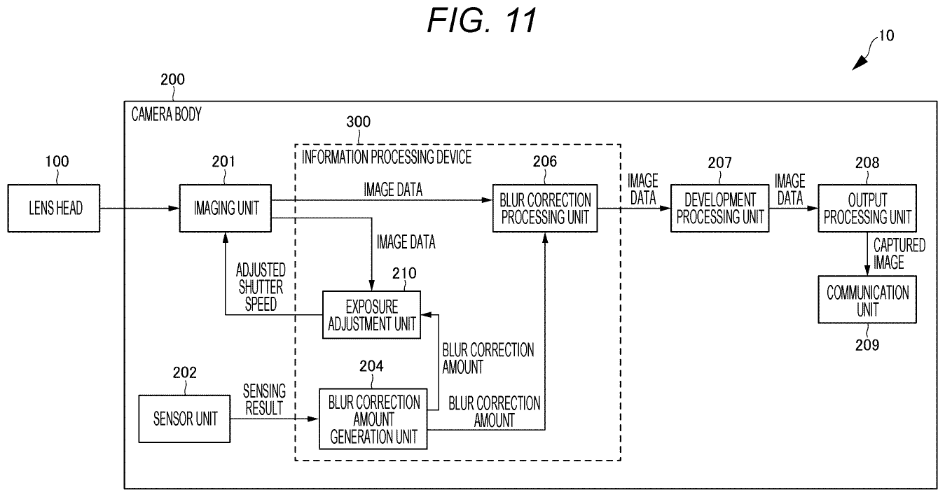

Next, a second embodiment of the present technology is described with reference to FIG. 11. As for the configurations of an imaging device 10 and an information processing device 300, only the processing unit that performs processing different from that of the first embodiment is described.

The blur correction amount generation unit 204 generates a blur correction amount, on the basis of a general blur correction algorithm or the like using the sensing result acquired from the sensor unit 202. The blur correction amount generation unit 204 outputs the blur correction amount to an exposure adjustment unit 210 and the blur correction processing unit 206.

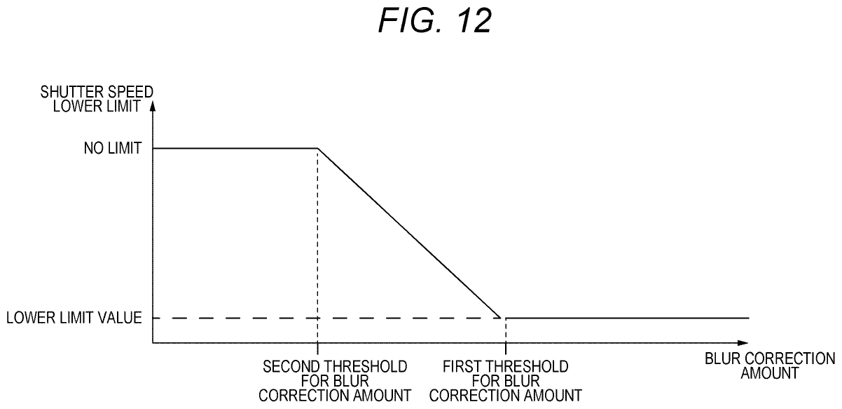

The exposure adjustment unit 210 determines an adjusted shutter speed by adjusting the shutter speed on the basis of the blur correction amount acquired from the blur correction amount generation unit 204 and adjustment data prepared in advance as illustrated in FIG. 12. The exposure adjustment unit 210 outputs the adjusted shutter speed to the imaging unit 201. The imaging unit 201 performs shutter control on the basis of the adjusted shutter speed. In this manner, a feature of the second embodiment lies in that the exposure adjustment unit 210 adjusts the shutter speed on the basis of the blur correction amount.

In the second embodiment, the lower limit value of the shutter speed (which is the maximum exposure time) is calculated from the blur correction amount, and this imposes a constraint on the exposure control circuit. First, the lower limit value of the shutter speed is calculated from the blur correction amount on the basis of the adjustment data illustrated in FIG. 12. The lower limit value is used as a limiting value for the shutter speed, to adjust the shutter speed. The point of no limit on the ordinate axis (the lower limit of the shutter speed) is determined by the capability value of the imaging device 10. In the case of a moving image, the frame rate is usually limited. On the other hand, the lower limit value is basically a value determined beforehand by the designer of the camera, but may be determined by the user.

Specifically, as illustrated in FIG. 12, in a case where the blur correction amount is equal to or greater than a first threshold, the shutter speed is made lower than that in a case where the blur correction amount is smaller than the first threshold, and is adjusted to the lower limit value. Further, in a case where the blur correction amount is equal to or smaller than a second threshold smaller than the first threshold, the shutter speed is made higher than that in a case where the blur correction amount is greater than the second threshold, and is adjusted to be unlimited. Further, in a case where the blur correction amount is equal to or greater than the second threshold, and is equal to or smaller than the first threshold, the shutter speed is adjusted so as to approach the lower limit value as the blur correction amount increases. Note that the characteristics of the adjustment data illustrated in FIG. 12 may change exponentially instead of linearly, or may change quadratically, and may be adjusted depending on the use case.

The blur correction processing unit 206 performs a blur correction process by an electronic blur correction method for cutting out an image of a predetermined size from the image data on the basis of the adjusted blur correction amount acquired from the blur correction amount generation unit 204. The blur correction method herein is similar to that in the first embodiment. The image data subjected to the blur correction process is output as a captured image after subjected to processing by the development processing unit 207 and the output processing unit 208.

The other aspects of the configurations of and the processes to be performed by the imaging device 10 and the information processing device 300 are similar to those of the first embodiment.

In the above manner, the processing by the information processing device 300 according to the second embodiment is performed. According to the second embodiment, when the blur correction amount is reduced to weakly suppress a change in composition, for example, the shutter speed becomes lower, and a motion blur is also weakly suppressed. Thus, strangeness in the captured image can be reduced, as in the first embodiment.

Further, when the blur correction amount is increased to strongly suppress a change in composition, the shutter speed becomes higher, and a motion blur is strongly suppressed. Thus, strangeness in the captured image can be reduced, as in the first embodiment. In this manner, it is also possible to adopt a setting such that the blur correction amount is prioritized, the shutter speed is increased to shorten the exposure time in a case where a large blur correction amount is required, and the shutter speed is decreased to secure the necessary exposure time in a case where only a small blur correction amount is required. In this case, when the imaging device 10 moves, the exposure time changes, and the brightness changes. Therefore, the captured image is desirably adjusted to have constant brightness through adjustment of the ND, the iris, the gain, or the like.

### 3. Third Embodiment

### [3-1. Configurations of an Imaging Device 10 and an Information Processing Device 300, and Processing to Be Performed by the Information Processing Device 300]

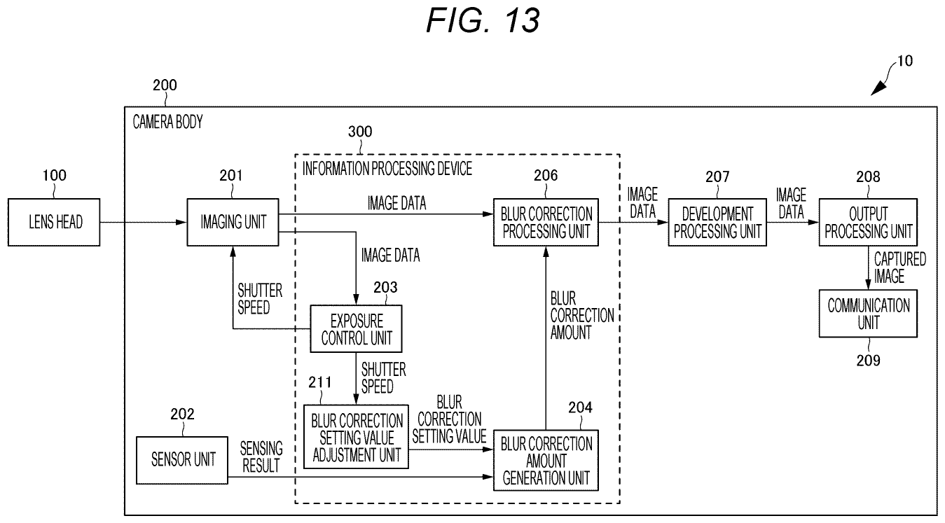

Next, a third embodiment of the present technology is described with reference to FIG. 13. As for the configurations of an imaging device 10 and an information processing device 300, only the processing unit that performs processing different from that of the first embodiment is described.

The exposure control unit 203 sets the shutter speed for adjusting the exposure time, on the basis of the user's input, the functions provided beforehand in the imaging device 10, or the like. The exposure control unit 203 outputs the set shutter speed to the imaging unit 201 and a blur correction setting value adjustment unit 211.

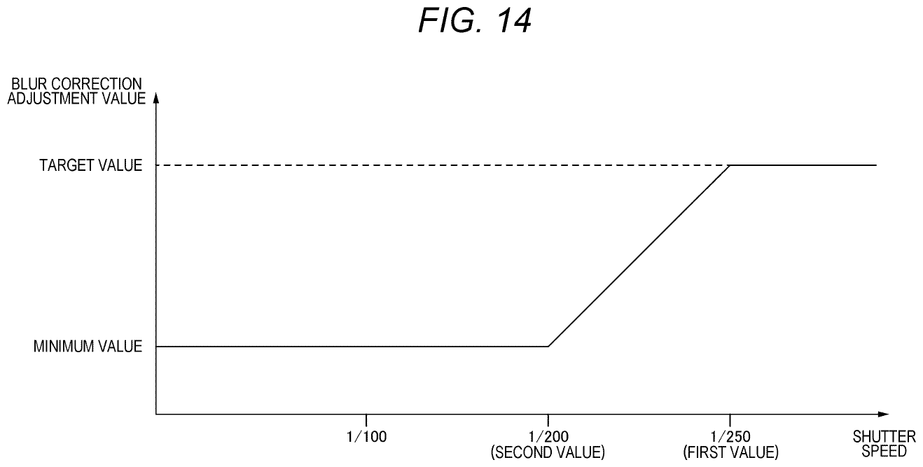

On the basis of the shutter speed acquired from the exposure control unit 203 and the adjustment data prepared in advance as illustrated in FIG. 14, the blur correction setting value adjustment unit 211 adjusts the blur correction setting value to be used by the blur correction amount generation unit 204 in the calculation for generating the blur correction amount. The blur correction setting value corresponds to the value related to blur correction in the claims. The blur correction setting value may be a correction following speed, a cutoff frequency, or the like, for example. However, the blur correction setting value is not limited to this, and any value that is used in the calculation for generating the blur correction amount may be used. In this manner, a feature of the third embodiment lies in that the blur correction setting value adjustment unit 211 adjusts the blur correction setting value on the basis of the shutter speed.

Specifically, as illustrated in FIG. 14, in a case where the shutter speed is equal to or higher than a first speed, the blur correction setting value is made greater and is adjusted to the target amount. Also, in a case where the shutter speed is equal to or lower than a second speed lower than the first speed, the blur correction setting value is made smaller and is adjusted to the minimum amount. Further, in a case where the shutter speed is equal to or higher than the second speed, the blur correction setting value is adjusted so as to approach the target amount as the shutter speed increases. Note that the characteristics of the adjustment data illustrated in FIG. 14 may change exponentially instead of linearly, or may change quadratically, and may be adjusted depending on the use case.

The blur correction amount generation unit 204 generates a blur correction amount, on the basis of a general blur correction algorithm or the like using a sensing result acquired from the sensor unit 202 and the blur correction setting value acquired from the blur correction setting value adjustment unit 211. In a case where the blur correction setting value is adjusted to a lower value, the correction amount generated by the blur correction amount generation unit 204 also becomes smaller. In a case where the blur correction setting value is adjusted to a higher value, the blur correction amount also becomes larger. The blur correction amount generation unit 204 outputs the blur correction amount to the blur correction processing unit 206.

The blur correction processing unit 206 performs a blur correction process by an electronic blur correction method for cutting out an image of a predetermined size from the image data on the basis of the blur correction amount. The blur correction method herein is similar to that in the first embodiment. The image data subjected to the blur correction process is output as a captured image after subjected to processing by the development processing unit 207 and the output processing unit 208.

The other aspects of the configurations of the imaging device 10 and the information processing device 300 are similar to those of the first embodiment.

In the above manner, the processing by the information processing device 300 according to the third embodiment is performed. According to the third embodiment, the present technology can be applied not only to a camera-shake correction amount, but also to adjustment of various setting values for generating the camera-shake correction amount. By adjusting the blur correction setting value on the basis of the shutter speed, and determining the adjusted blur correction amount on the basis of the blur correction setting value, it is possible to suppress a feeling of strangeness in the captured image as in the first embodiment.

### 4. Modifications

Although embodiments of the present technology have been specifically described above, the present technology is not limited to the above embodiments, and various modifications based on the technical idea of the present technology can be made.

In the first to third embodiments described above, the imaging device 10 has the functions as the information processing device 300, and all processes are performed in the imaging device 10. However, the present technology is not limited to that configuration.

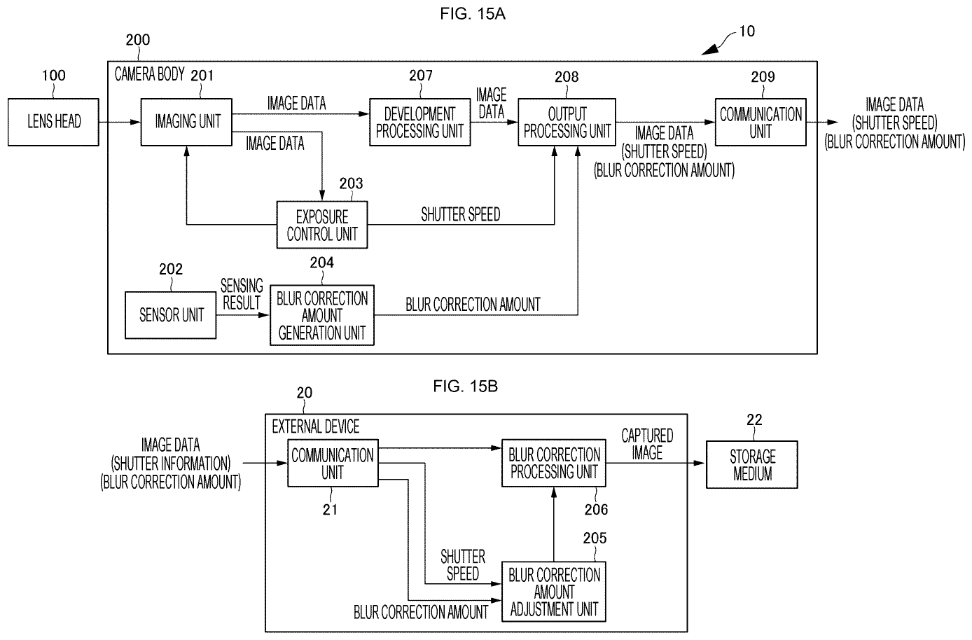

As illustrated in FIG. 15, the processes to be performed by the information processing device 300 may be divided between the imaging device 10 and an external device 20. In the example in FIG. 15, the imaging device 10 includes the exposure control unit 203 and the blur correction amount generation unit 204 as illustrated in FIG. 15A. Meanwhile, as illustrated in FIG. 15B, the external device 20 includes the blur correction amount adjustment unit 205 and the blur correction processing unit 206. The external device 20 may be a server, a personal computer, a smartphone, a tablet terminal, or the like, for example.

The imaging device 10 superimposes the shutter speed set by the exposure control unit 203 and the blur correction amount generated by the blur correction amount generation unit 204 as metadata on image data, and transmits the image data to the external device 20. The setting of the shutter speed and the generation of the blur correction amount are similar to those in the first embodiment.

The external device 20, which has received the image data with the communication unit 21, then outputs the image data to the blur correction processing unit 206. Further, the shutter speed and the blur correction amount as the metadata superimposed on the image data are output to the blur correction amount adjustment unit 205.

The blur correction amount adjustment unit 205 adjusts the blur correction amount in a manner similar to that in the first embodiment, and outputs the adjusted blur correction amount to the blur correction processing unit 206. The blur correction processing unit 206 then performs a blur correction process on the image data, on the basis of the adjusted blur correction amount. The image data subjected to the blur correction process is stored as a captured image into a storage medium 22, for example. Note that the captured image may be transmitted from the external device 20 to some other device.

Note that, in this modification, the blur correction amount generation unit 204 may be included in the external device 20, and the imaging device 10 may superimpose a sensing result acquired by the sensor unit 202 as metadata on the image data, and transmit the image data to the external device 20. In this case, the blur correction amount generation unit 204 generates the blur correction amount in the external device 20.

Next, a second modification in which fail-safe is executed is described. In a case where there is some abnormality in the sensing result output from the sensor unit 202, or where the sensor unit 202 breaks down, the blur correction processing unit 206 performs a blur correction process by cutting out a predetermined range with reference to the center of the image data as a fail-safe. As a result, even if there is an abnormality in the sensing result, outputs of captured images are not interrupted, and it is possible to avoid hindrance to broadcasting using the captured images, for example.

The cutting out of the predetermined range with reference to the center of the image data can be performed by the blur correction amount generation unit 204 generating “0” as the blur correction amount, for example. As the blur correction amount is set to 0, even if the blur correction amount is adjusted by the blur correction amount adjustment unit 205, “0” is always obtained when “0” is multiplied by a magnification (0 to 1). As a result, cutting out with reference to the center is performed.

As described above, the determination as to whether or not to execute fail-safe may be performed by the blur correction amount generation unit 204 that receives a sensing result from the sensor unit 202, may be performed by a control unit or the like included in the imaging device 10, or may be performed by a processing unit dedicated to determination.

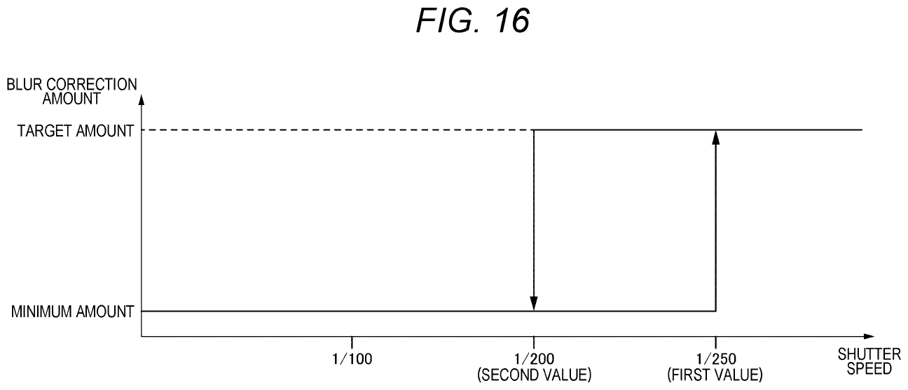

Further, the adjustment data for adjusting the blur correction amount is not limited to that illustrated in FIG. 9, but may have characteristics with hysteresis as illustrated in FIG. 16, for example. A plurality of pieces of adjustment data may be prepared for each imaging environment (indoor, outdoor, and the like), for example, and the adjustment data to be used may be selected depending on the imaging environment. Also, a plurality of pieces of adjustment data may be prepared for each type of the subject P, and the adjustment data to be used may be selected depending on the subject P. For example, adjustment data selected beforehand by the user from among a plurality of pieces of adjustment data may be used, or a control unit (not shown) of the imaging device 10 may recognize the imaged scene (the imaging environment or the subject) using image data transmitted from the imaging unit 201, and select the adjustment data on the basis of a recognition result.

Further, in the embodiments described above, the lens head 100 including the lens 101 is replaceable with respect to the camera body 200, but the present technology is also applicable to an imaging device in which the lens 101 and the camera body 200 are integrally formed.

Also, the present technology can be applied to any device that has a camera function, such as a smartphone, a personal computer, a tablet terminal, a portable game machine, or a wearable device.

Furthermore, the present technology is not limited to still images, and can also be applied to frame images constituting a moving image.

The present technology may also have the following configurations.

(1)

An information processing device including

an adjustment unit that adjusts one of a value related to blur correction in an imaging device or a shutter speed, the imaging device including an electronic blur correction function that corrects a blur of image data and a control function for the shutter speed.

(2)

The information processing device according to (1), in which the value related to blur correction is a blur correction amount indicating an amount of movement of a cutout position of image data in electronic blur correction.

(3)

The information processing device according to (2), in which the adjustment unit is a blur correction amount adjustment unit that adjusts the blur correction amount on the basis of the shutter speed.

(4)

The information processing device according to (3), further including a blur correction amount generation unit that generates a target amount of the blur correction amount, on the basis of a result of sensing of movement of the imaging device.

(5)

The information processing device according to (4), in which the blur correction amount adjustment unit determines a minimum amount of the blur correction amount, on the basis of the target amount of the blur correction amount.

(6)

The information processing device according to (4) or (5), in which in a case where the shutter speed is not lower than a first speed, the blur correction amount adjustment unit adjusts the blur correction amount to the target amount.

(7)

The information processing device according to (5) or (6), in which in a case where the shutter speed is not higher than a second speed that has a smaller value than the first speed, the blur correction amount adjustment unit adjusts the blur correction amount to the minimum amount.

(8)

The information processing device according to any one of (5) to (7), in which the blur correction amount adjustment unit adjusts the blur correction amount to approach the target amount from the minimum amount as the shutter speed approaches the second speed from the first speed.

(9)

The information processing device according to (2), in which the adjustment unit is an exposure adjustment unit that adjusts the shutter speed on the basis of the blur correction amount.

(10)

The information processing device according to any one of (1) to (9), in which the value related to blur correction is a blur correction setting value to be used in calculation of the blur correction amount.

(11)

The information processing device according to (10), in which the blur correction setting value is a blur correction following speed.

(12)

The information processing device according to (10), in which the blur correction setting value is a cutoff frequency.

(13)

The information processing device according to any one of (10) to (12), in which the adjustment unit is a blur correction setting value adjustment unit that adjusts the blur correction setting value on the basis of the shutter speed.

(14)

The information processing device according to any one of (10) to (13), further including a blur correction amount generation unit that generates a blur correction amount on the basis of the blur correction setting value.

(15)

The information processing device according to any one of (1) to (14), further including a blur correction processing unit that performs a blur correction process on the image data.

(16)

The information processing device according to any one of (1) to (15), further including an imaging unit that generates the image data.

(17)

The information processing device according to (15), in which in a case where there is an abnormality in a result of sensing of movement of the imaging device, the blur correction processing unit performs a blur correction process by cutting out a predetermined range with reference to a center of the image data.

(18)

The information processing device according to any one of (1) to (17), in which the adjustment unit adjusts one of the value related to blur correction or the shutter speed, on the basis of the adjustment data selected from among a plurality of pieces of adjustment data.

(19)

An information processing method including adjusting one of a value related to blur correction in an imaging device or a shutter speed, the imaging device including an electronic blur correction function that corrects a blur of image data and a control function for the shutter speed.

(20)

A program for causing a computer to implement an information processing method including

adjusting one of a value related to blur correction in an imaging device or a shutter speed, the imaging device including an electronic blur correction function that corrects a blur of image data and a control function for the shutter speed.

### REFERENCE SIGNS LIST

10 Imaging device
201 Imaging unit
204 Blur correction amount generation unit
205 Blur correction amount adjustment unit
206 Blur correction processing unit
210 Exposure adjustment unit
211 Blur correction setting value adjustment unit
300 Information processing device

1. An information processing device comprising
an adjustment unit that adjusts one of a value related to blur correction in an imaging device or a shutter speed, the imaging device including an electronic blur correction function that corrects a blur of image data and a control function for the shutter speed.

2. The information processing device according to claim 1, wherein
the value related to blur correction includes a blur correction amount indicating an amount of movement of a cutout position of image data in electronic blur correction.

3. The information processing device according to claim 2, wherein
the adjustment unit includes a blur correction amount adjustment unit that adjusts the blur correction amount on a basis of the shutter speed.

4. The information processing device according to claim 3, further comprising a blur correction amount generation unit that generates a target amount of the blur correction amount, on a basis of a result of sensing of movement of the imaging device.

5. The information processing device according to claim 4, wherein
the blur correction amount adjustment unit determines a minimum amount of the blur correction amount, on a basis of the target amount of the blur correction amount.

6. The information processing device according to claim 4, wherein
in a case where the shutter speed is not lower than a first speed, the blur correction amount adjustment unit adjusts the blur correction amount to the target amount.

7. The information processing device according to claim 5, wherein
in a case where the shutter speed is not higher than a second speed that has a smaller value than the first speed, the blur correction amount adjustment unit adjusts the blur correction amount to the minimum amount.

8. The information processing device according to claim 5, wherein
the blur correction amount adjustment unit adjusts the blur correction amount to approach the target amount from the minimum amount as the shutter speed approaches the second speed from the first speed.

9. The information processing device according to claim 2, wherein
the adjustment unit includes an exposure adjustment unit that adjusts the shutter speed on a basis of the blur correction amount.

10. The information processing device according to claim 1, wherein
the value related to blur correction includes a blur correction setting value to be used in calculation of the blur correction amount.

11. The information processing device according to claim 10, wherein
the blur correction setting value includes a blur correction following speed.

12. The information processing device according to claim 10, wherein
the blur correction setting value includes a cutoff frequency.

13. The information processing device according to claim 10, wherein
the adjustment unit includes a blur correction setting value adjustment unit that adjusts the blur correction setting value on a basis of the shutter speed.

14. The information processing device according to claim 10, further comprising a blur correction amount generation unit that generates a blur correction amount on a basis of the blur correction setting value.

15. The information processing device according to claim 1, further comprising a blur correction processing unit that performs a blur correction process on the image data.

16. The information processing device according to claim 1, further comprising an imaging unit that generates the image data.

17. The information processing device according to claim 15, wherein
in a case where there is an abnormality in a result of sensing of movement of the imaging device, the blur correction processing unit performs a blur correction process by cutting out a predetermined range with reference to a center of the image data.

18. The information processing device according to claim 1, wherein
the adjustment unit adjusts one of the value related to blur correction or the shutter speed, on a basis of the adjustment data selected from among a plurality of pieces of adjustment data.

19. An information processing method comprising
adjusting one of a value related to blur correction in an imaging device or a shutter speed, the imaging device including an electronic blur correction function that corrects a blur of image data and a control function for the shutter speed.

20. A program for causing a computer to implement an information processing method including
adjusting one of a value related to blur correction in an imaging device or a shutter speed, the imaging device including an electronic blur correction function that corrects a blur of image data and a control function for the shutter speed.
